(19) United States
(12) Patent Application Publication
(10) Pub. No.: US 2011/0168770 A1
(43) Pub. Date: Jul. 14, 2011

(54) TEAR-PROPAGATION RESISTANT ENVELOPE

(75) Inventors: Paul F. Ostwald, Queensbury, NY (US); Thomas D. Wetsch, St. Charles, IL (US)

(73) Assignee: Pregis Innovative Packaging, Inc., Deerfield, IL (US)

(21) Appl. No.: 12/945,006

(22) Filed: Nov. 12, 2010

Related U.S. Application Data
(60) Provisional application No. 61/260,774, filed on Nov. 12, 2009.

(51) Int. Cl. B65D 27/02; B65D 27/38; B31B 19/74

(52) U.S. Cl. 229/311; 493/214; 493/243

(57) ABSTRACT

An envelope can include a first wall with a first edge, a second wall with a second edge connected to the first edge along a connected portion configured for providing a side of the envelope, the first and second edges respectively including first and second separate portions that are separate from each other, the separate portions extending from the connected portions at a transition location and a reinforcing member associated with the connected portion adjacent the transition location for reinforcing the connected portion adjacent the transition location. An apparatus for making an envelope is also disclosed.

### CROSS REFERENCE TO RELATED APPLICATION

The present application claims priority from U.S. Provisional Ser. No. 61/260,774 filed Nov. 12, 2009, the disclosure of which is incorporated herein by reference in its entirety.

### FIELD OF THE INVENTION

The present disclosure relates to envelopes for use in shipping items.

### BACKGROUND

Envelopes for use in shipping items can be handled by several people and machines in the process of making the envelopes, the process of inserting an item in the envelope, and in the process of shipping the envelope. During shipping, the envelope can be handled as it is loaded into and out of baskets, transporting vehicles, and/or loaded onto and off of conveying or transporting machinery. The envelope is expected to hold up to this handling to protect the shipping item from start to finish where the shipping item is not released from the envelope nor is debris or other unwanted material allowed to enter the envelope.

Several technologies have developed to create cost effective yet relatively strong envelopes. Often, envelopes can be made from paper based materials and can be folded to form an envelope. In some instances padding can be provided formed from paper based materials, air filled materials, or textile materials. In many cases relatively strong tapes and/or adhesives can be used to close the envelopes and prevent them from opening between departure locations and their destination.

### SUMMARY

In one embodiment, an envelope can include a first wall with a first edge and a second wall with a second edge connected to the first edge along a connected portion configured for providing a side of the envelope. The first and second edges respectively can include first and second separate portions that are separate from each other and that extend from the connected portions at a transition location. A reinforcing member can also be included that is associated with the connected portion adjacent the transition location for reinforcing the connected portion adjacent the transition location.

The reinforcing member of the above embodiment can be secured to and extend across the first and second edges. The reinforcing member can further be adhered to the connected portion and can include a strip of sheet material. The separate portions of the above embodiment can be separated by a slit and the first and second walls can define a slit with a sharp tip at the transition location. The reinforcing member can be configured and associated with the connected portion for stopping tearing therethrough from the transition location. The reinforcing member can be disposed adjacent to, but not over the separate portions. Alternatively, the reinforcing member can be placed over a portion of the separate portions.

In some embodiments, the first and second walls can include paper sheet material. The first and second walls can be multi-layered, having a plurality of sheet layers, including the paper sheet material. The plurality of layers can include inner and outer layers of paper sheet material. The first and second walls can include a filling layer disposed between the inner and outer layers. The filling layer can include a plurality of pellets forming a cushion and the cushion can be macerated paper.

In some embodiments, the first wall includes a third edge and the second wall includes a fourth edge connected to the third edge along another connected portion configured for providing another side of the envelope. The third and fourth edges respectively can include third and fourth separate portions that are separate from each other, the third and fourth separate portions extending from the another connected portions at another transition location. Another reinforcing member can be included associated with the another connected portion adjacent the another transition location for reinforcing the another connected portions adjacent the another transition location. In this embodiment, the first and second wall and the connected portion and the another connected portion can define a containment space therebetween. The portion of the first wall and the second wall disposed between the separated portions can comprise a flap, the flap of the first wall being foldable over the second wall and secured thereto for closing the envelope. Additionally, an adhesive can be disposed for adhering the flap of the first wall to the second wall upon contact therebetween.

In still another embodiment, a first portion of the second wall can be positioned adjacent a first side of the first wall separated by a first fold line and a second portion of the second wall can be positioned adjacent a second side of the first wall separated by a second fold line, the first and second portions of the second wall being foldable along the fold lines and connectable to form a containment space.

In another embodiment, an apparatus for making an envelope from a sheet can include a plurality of rollers arranged to support the sheet and allow the sheet to pass there across. The apparatus can also include a slitter positioned opposed to the plurality of rollers and on an opposite side of the sheet from the plurality of rollers. An applicator for applying reinforcing members to the sheet and being positioned downstream from the slitter and on the opposite side can also be provided.

### BRIEF DESCRIPTION OF FIGURES

FIG. 1 shows a back view of an envelope according to certain embodiments;

FIG. 2 shows a front view thereof;

FIG. 3 shows a close-up back perspective view of an opening end of the envelope of FIG. 1;

FIG. 4 shows a web being processed to construct the envelope of FIG. 1;

FIG. 4A shows a close-up view of the application of a reinforcing member;

FIG. 5 shows a portion of the web of FIG. 4 in the form of a blank at one stage of construction;

FIG. 6 shows a back perspective view of a partially constructed envelope having been chopped from a row of blanks; and

FIG. 7 shows an apparatus for making the envelope of FIG. 1.

### DETAILED DESCRIPTION

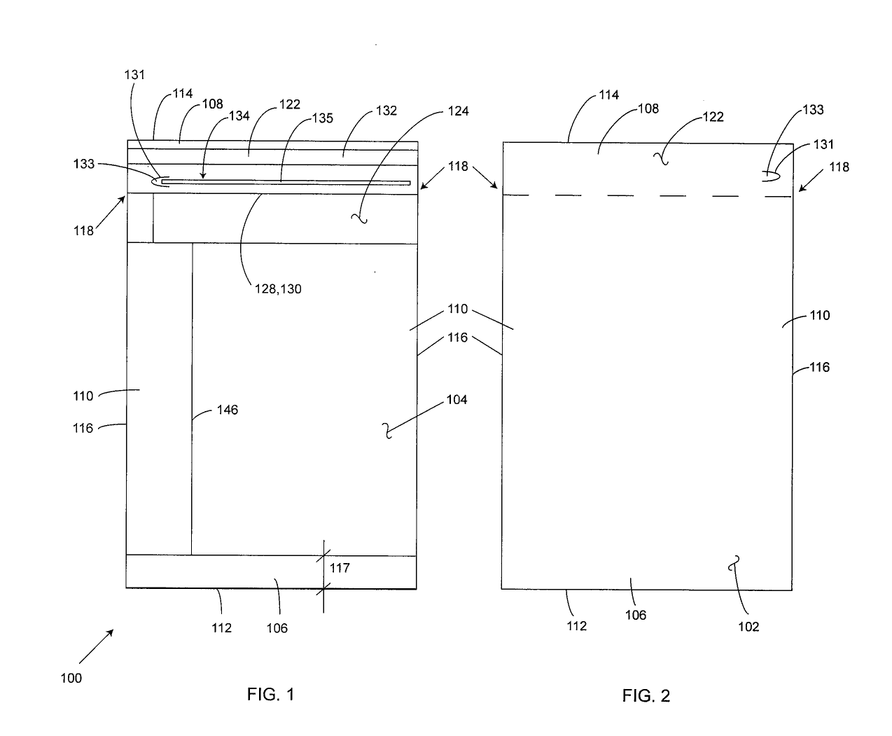

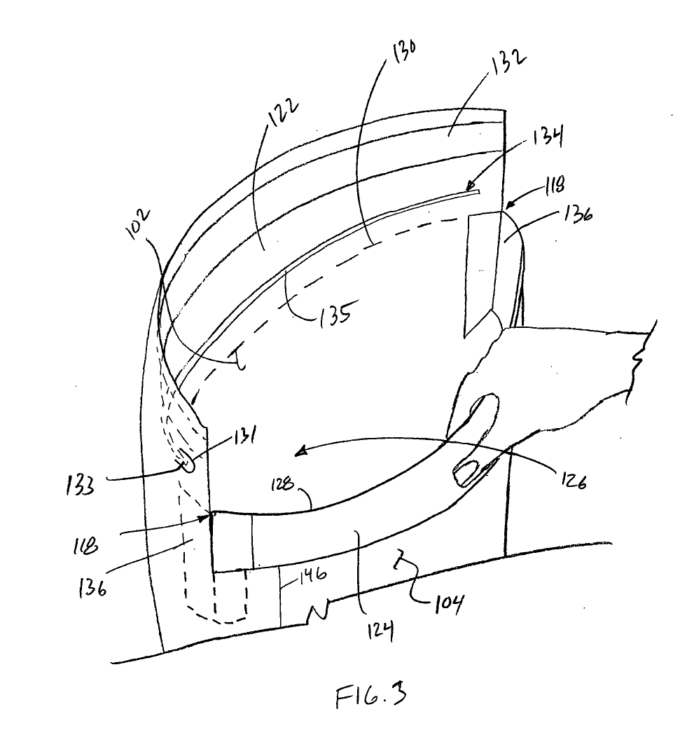

Referring to FIGS. 1 and 2, a preferred embodiment of envelope 100 includes a surrounding structure arranged to form a containment space. The surrounding structure can include one or more walls adapted to keep shipping items in and debris, dirt, and water out. The envelope can include an opening and it can include one or more closure elements with associated securing members adapted to cover the opening and prevent dislodgement of a shipping item after insertion of the shipping item into the containment space.

The envelope 100 can be configured as a mailer, such as a padded envelope. Envelope 100 can include a surrounding structure in the form of walls arranged in opposing position to one another. The surrounding structure shown can include a generally rectangular front wall 102 and a generally rectangular back wall 104 with inside faces directed toward one another and outside faces directed away from one another. Each of the front and back wall 102, 104 include a closed edge 106, an opening edge 108, and two lateral edges 110. In the embodiment shown, the front wall 102 and the back wall 104 are congruent and the corresponding edges form ends and/or sides of the envelope 100. That is, the closed edges 106 together form a closed end 112, the opening edges 108 form an opening end 114, and the lateral edges 110 form lateral sides 116 of the envelope 100. Other relationships other than congruent walls can be provided and other wall shapes can be provided. Regarding congruency, for example, a closed edge 106 of one wall can connect to an opposing wall within the boundary defined by the opposing wall and not at the corresponding opposing wall edge. In this case the walls might not be congruent and might not be the same shape. Regarding shapes, triangular or circular walls can be provided. Other shapes can be provided. Additionally, a single wall can be provided and can be in the form of a cylindrical wall or a cone shaped wall where two ends of a material are connected to each other.

The front and back wall 102, 104 can be fully or partially connected to one another along their respective edges or the edges can be free edges. Where connections are provided, the connection can be an adhesive type connection, a staple connection, a stitched connection, or a folded connection. Other connections can be used, for example, a living hinge, where the front and back wall 102, 104 are continuous through a fold to form an end or side of the envelope 100.

In the embodiment shown, the closed edges 106 of the front and back wall 102, 104 are fully connected to one another. The closed edges 106 are adhered to one another, preferably along their length, preferably within most, all, or part of width 117. The area of adherence of the back wall 104 to the front wall 102 defines an inside edge bordering the containment space and defining the closed end boundary for the containment space. The closed edges 106 are further folded about the inside edge of the adherence area in a rearward fashion and further against the back wall 104 and adhered thereto. The closed edges 106 can be adhered to one another and further to the back wall 104 with an adhesive. The adhesive can include one of several types of glue including cold or hot glue. In a preferred embodiment, the adhesive is a polyvinyl alcohol cold glue. The glue can be applied in several ways including rollers, a glue bar, a dispensing nozzle, a spray nozzle, or a mist. Other methods of application can also be used.

Regarding the opening edges 108, these edges, in the embodiment shown, are free edges and are not connected to one another. The free edges 108 form an opening into the containment space.

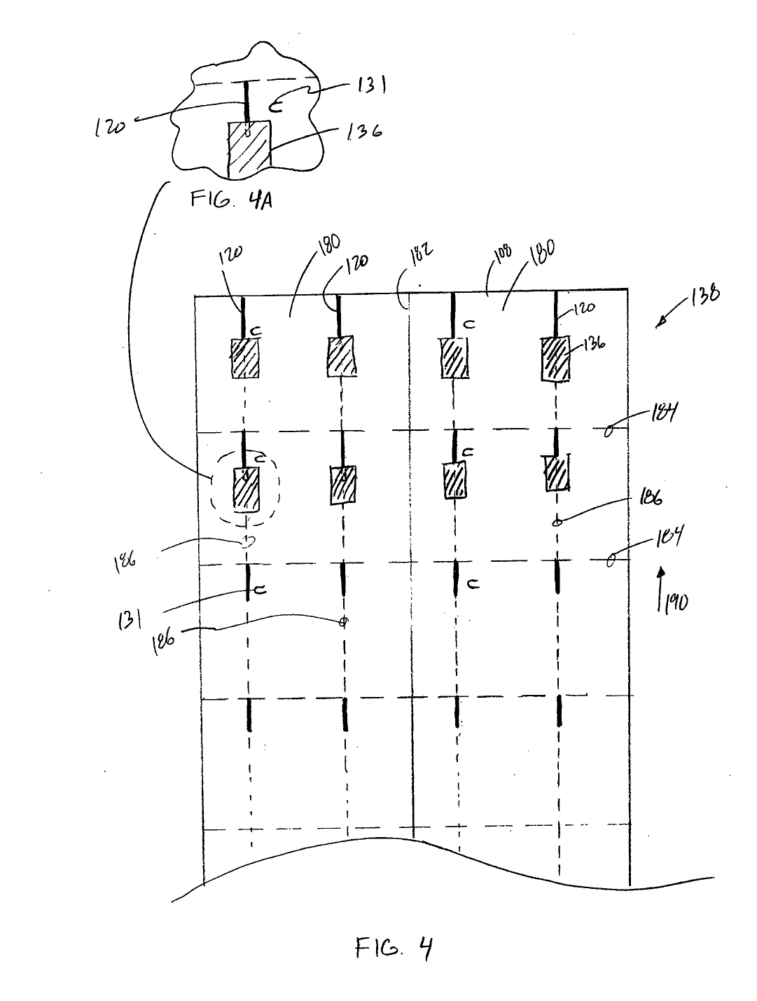

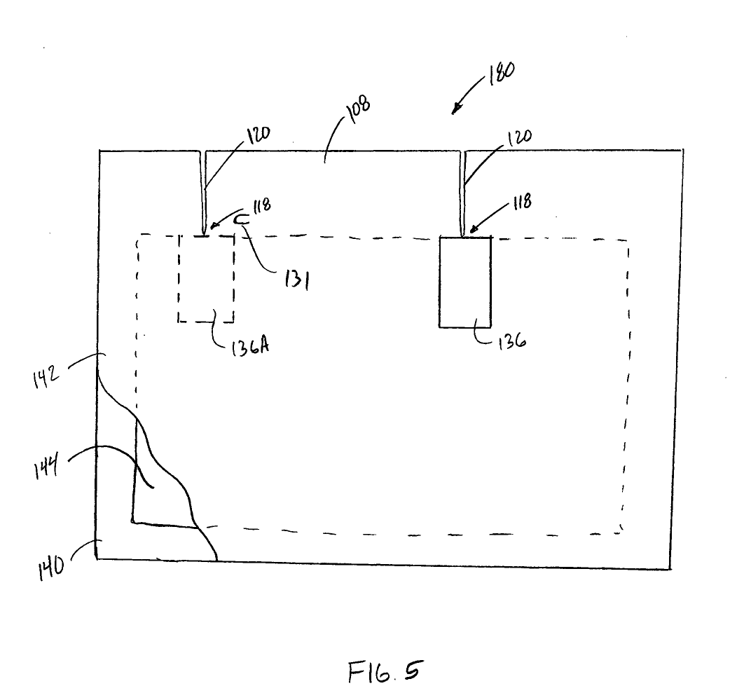

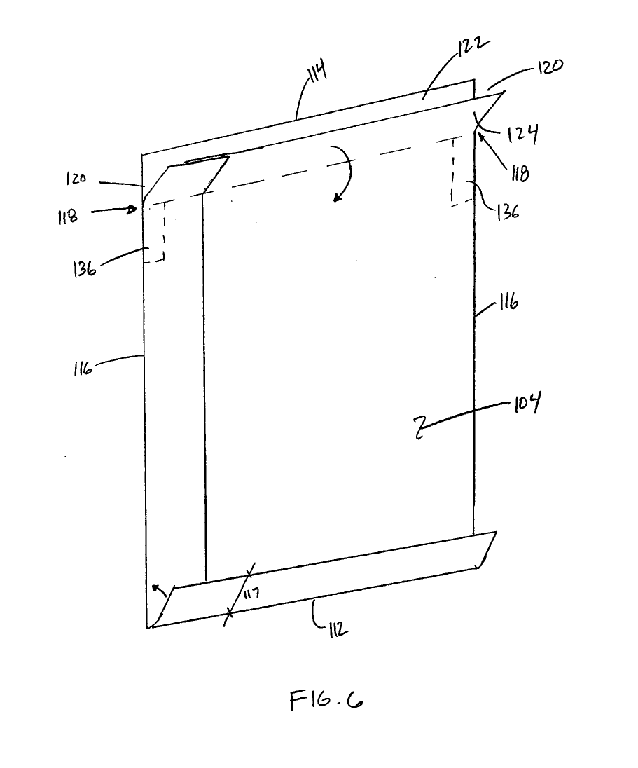

Regarding the lateral edges 110, the embodiment shown includes living hinges extending partially along the length of the lateral sides 116 of the envelope 100 and defining the lateral boundary of the containment space. The connection along the lateral side 116 creates a connection portion that begins at the closed end 112 and extends toward the opening end 114 of the envelope 100. The connection stops short of the opening end 114 at a transition location, which in the preferred embodiment is configured as a transition point 118, creating a separate portion and defining a slit 120 between the front and back wall 102, 104 along the lateral side 116 of the envelope 100. The slit 120 is shown best in FIGS. 4 and 5 relating to the method of making the envelope 100. The slit 120 has a length extending from the transition point 118 to the opening end 114 of the envelope 100. The slit 120 can have a length of approximately ½ inch to approximately 4 inches. In the present embodiment, the slit 120 has a length of approximately 2 inches. The slit length can include lengths outside the range mentioned and can be adapted to accommodate several envelope sizes. In the embodiment shown, both lateral sides 116 of the envelope 100 are partially connected and include equal length slits 120. As such, the slits 120, together with the opening edge 108 of each of the front and back walls 102, 104, defines a front and back flap portion 122, 124 of the respective front and back walls 102, 104. As shown, the flap portions 122, 124 are generally rectangular flaps extending along the opening end 114 of the envelope 100. As can be seen from a review of FIG. 3, the slit length can define the size of the flaps and thus can be adjusted to provide a front flap 122 with sufficient size to be grasped by a user. In some embodiments, the front flap 122 can be large to allow for bulky items that may have a tendency to spread the opening end 114 of the envelope 100 when inserted. In other embodiments, the slit may be shorter so as to maximize the size of the containment space within the envelope 100. In the preferred embodiment, the slit 120 is provided by cutting the sheet from which the envelope 100 is formed. The cut is preferably straight and can be a simple shear without removing a substantial amount of the sheet. In other embodiments, the slit can include the removal of material and can form a u-shaped slit, tear drop shaped slit, or elliptically shaped slit with a rounded end at the transition point 118. In the embodiment shown, the congruent walls 102, 104 together with the generally straight slits 120 causes the flap portions 122 and 124 to also be congruent. Alternative slits can be provided at an angle to the lateral side 116, or by removing material to provide a wider rectangular or non-rectangular slit. The slits, for example, can be triangular or curved to provide different shapes of the flaps 122, 124, such as a trapezoidal shape. The slits can also be positioned in a location not in alignment with a fold or edge.

Referring now to FIG. 3, a close-up back perspective view of the opening end 114 of the envelope 100 is shown. As shown, the back wall flap 124 can be folded against the back wall 104 and secured, such as with an adhesive, to expose the opening 126 and allowing the front wall flap 122 to function as a closure element, and so that the front wall 102 is taller than the back wall 104. The back wall flap 124 is shown folded about a back wall fold line 128 extending along the back wall 104 between the transition points 118 of each of the slits 120. The back wall fold line 128 can define the opening end boundary of the containment space. The front wall flap 122 is shown extending beyond the back wall fold line 128 and can be foldable about a front wall fold line 130 extending along the front wall 102 between the transition points 118 of the envelope 100. Alternatively, the front wall fold line can be spaced away from a line extending between the transition points 118. For example, the front wall fold line 130 can be positioned nearer to the opening end than the back wall fold line. The front wall flap 122 can include a securing member 132. The securing member 132 can include an internally facing adhesive strip, such as covered by a peel-away, or otherwise removable, cover tape as shown. In a preferred embodiment, the securing member 132 can be a hot melt glue, such as a pressure sensitive adhesive, applied with a release liner. Other securing members 132 can include lick and stick systems, buttons, clips, hook and loop, external stickers or sealing systems, and cohesive for resealability. Other securing members 132 can be provided.

A member to facilitate opening of the sealed envelope 100 can also be provided, such as on or adjacent the front flap 122 or on another part of the envelope 100. A weakened area can be provided, and or an opener member 134 can be provided, which in the preferred embodiment includes a cut-out tab 133 that is partially cut from the envelope 100, and a pull-strip 135 of greater strength than the material of the envelope 100 to which it is attached, thus enabling the tab 133 to initiate a tear that is continued by the pull strip 135 to open the envelope 100 after sealing articles in the containment space. The cut-out tab 133 can be positioned on the front wall flap 122 near a lateral side 116 of the envelope 100 and adjacent the front wall fold line 130. The pull-strip 135 can be adhered to the inside surface of the front wall flap 122 beginning on the inside surface of the cut-out tab 133 and extending across the front wall flap 122 adjacent to the front wall fold line 130.

A reinforcing member 136 is also provided in the embodiment shown. The reinforcing member 136 can be configured and associated with the connected portion of the lateral side 116 adjacent the transition location for reinforcing the connected portion adjacent the transition location. The reinforcing member 136 can be adapted to stop and/or prevent propagation of the slit 120, such as by tearing at the transition location. Preferably, the reinforcing member 136 can be positioned adjacent or overlapping with slits 120 along seams, folds, or edges that may have a tendency to tear more readily and thus the member 136 can resist or prevent propagation of a slit along said seam, fold, or edge. Alternatively or additionally, the reinforcing member 136 can be positioned adjacent to or overlapping with slits not along seams, folds, or edges. The reinforcing member 136 can extend generally parallel to or perpendicular to the slit 120 and can be positioned generally adjacent the base of the slit 120. The reinforcing member 136 can be secured to and extend across the lateral edges 110 of the front and back portions 102, 104 and can be adhered to the connected portion of the lateral edges 110. The reinforcing member 136 can be disposed generally adjacent to the separate portions, where it may overlap the slit slightly or not. For example, in cases where the slit 120 is overly long, as shown in FIG. 4A, the reinforcing member can overlap slightly to adjust the length of the slit 120. In a preferred embodiment, the reinforcing member does not overlap the separate portions of the lateral edges 110. Typically, the reinforcing members 136 on a series of blanks would all be adjacent to the slit 120 or overlap the slit 120 slightly, depending on the intended placement. In FIG. 4, both options are shown for purposes of explanation.

The reinforcing member 136 can extend laterally relative to the lateral side 116 of the envelope 100 beyond the slit 120 and out onto each wall 102, 104. The reinforcing member 136 can extend onto each wall 102, 104 a relatively short distance or a relatively long distance depending on the nature of the anticipated forces and the nature of the materials adjacent the slit 120. In some embodiments, the reinforcing member can extend fully across each of the front and back walls 102, 104 and, thus, be generally continuous about the opening end 114 of the envelope 100. Preferably, the distance beyond the lateral side 116 to which the reinforcing member 136 extends and is affixed to the walls 102, 104 is sufficient to prevent or significantly reduce tearing propagating from the slit 120 down along or around the lateral side 116 of the envelope 100. The reinforcing member 136, for example, can be rectangular, such as square or elongated. Other shapes can be used. Additionally or alternatively, the reinforcing member 136 can also spread laterally relative to the direction of the tensile force passing across the base of the slit 120. That is, as the reinforcing member 136 extends beyond the slit 120 and out onto each wall 102, 104, the reinforcing member 136 can fan out or otherwise broaden its shape when compared to the portion of the member 136 passing across the base of the slit 120.

The geometry described can allow the reinforcing member 136 to be adapted to transfer and diffuse tensile or tearing forces away from the base of the slit 120. The geometry can also help to hold the walls 102, 104 together in response to forces acting across the lateral side 116 of the envelope 100 and tending to pull the walls 102, 104 away from each other to help avoid a tear initiating at the slit 120. As such, a tendency for the portions of material positioned on each side of the slit 120 to move away from each other and cause the base of the slit 120 to tear can be minimized and/or prevented. The length of the member 136 or breadth of the member 136 on either side of the slit 120 can affect the distribution of tensile forces to the materials adjacent to the slit 120. As such, where the reinforcing member 136 is relatively long and/or broad, the force can be distributed to a larger portion of the material on either side of the slit 120 and thus minimize a tendency for the material to tear or fail at the connection of the reinforcing member 136 to the material.

In the present embodiment, propagation of the slit 120 can be prevented from extending down the lateral side 116 of the envelope 100 or into either of the front or back walls 102, 104 of the envelope 100. The reinforcing member 136 can thus be positioned on the inside and/or the outside of the front wall 102 and the back wall 104 extending across the lateral side 116 of envelope 100 and across the front and back walls 102, 104 of the envelope 100. In some embodiments, the reinforcing member 136 can be positioned within the walls as show best in FIG. 5 as element 136A. The reinforcing member 136 can be positioned adjacent to the transition point 118 and on the opposite side of the transition point 118 from the slit 120. The reinforcing member 136 will typically extend beyond the slit 120 and across each of the walls 102, 104 for a distance ranging from approximately ½ inch to approximately 3 inches, making the length of the reinforcing member 136 approximately 1 inch to approximately 6 inches. In the embodiment shown, the reinforcing member 136 extends approximately 1 inch across each of the walls 102, 104 making the length of the reinforcing member 136 approximately 2 inches. The reinforcing member 136 can extend away from the slit 120 along the lateral side 116 of the envelope 100 a distance ranging from approximately ½ inch to approximately 4 inches. In the embodiment shown, the reinforcing member 136 extends along the lateral side 116 a distance of approximately 2¾ inches. The size of the reinforcing member 136 both in the direction extending across the walls and the direction extending along the lateral side 116 can be adjusted to accommodate the strength of the walls, the bond between the member 136 and the walls, and the strength of the reinforcing material. Accordingly, sizes smaller or larger than that shown or described can be used. The reinforcing member 136 can be adhered to the walls with an adhesive, stitched to the walls, or otherwise connected to the walls. The reinforcing member 136 can include a strip of sheet material. For example, the reinforcing member can be an adhesive tape material, such as a paper, fabric, plastic, or metal material tape, which can have a pre-applied adhesive prior to assembly. Suitable tapes can include, for example, repulpable, paper, reinforced, bidirectional filament, pre-gummed fiber glass reinforced, duct, masking, packaging, reinforced masking, gorilla, transparent duct, splicing, or paper packing tape. Other suitable tapes can be provided. Additionally or alternatively, a spray-on adhesive with an added mesh can be provided or an adhesive with a gum tape or paper for added strength. The tape can be single sided and can range from approximately ½″ to approximately 6″ wide. Preferably, the tape can be from approximately 1″ to approximately 3″ wide.

The surrounding structure of the envelope can be made from a web extending generally in two dimensions and having a thickness. For example, a web can be used to form one or more walls of the envelope 100. The web can be adapted to contain items within the containment space. The web can be perforated in the form of a net or it can be generally solid in the form of a sheet. The web can include a single layer or it can be comprised of multiple layers. The several layers can be made of the same or different materials to develop respective flexibilities and hardnesses.

The layers can be relatively rigid, relatively flexible, or they can have an intermediate flexibility. For example, a relatively rigid layer may include various plastics, metals, woods, or cardboard materials (such as heavy card stock or corrugated or other types of cardboard). A relatively flexible layer may include relatively thin papers or plastics or textile based materials with flexibilities similar to that of grocery bags, canvas bags, or other bag type material. Layers with intermediate flexibilities may include heavier papers, card stock, plastics, or foils. Other materials can be used for any of the stated flexibilities and the materials mentioned are merely used as examples to convey various realms of flexibility. The flexibility of the layer or layers collectively of the web can define a flexibility of the web. Typically, each layer would be a paper from 35#/msf to 70#/msf paper stock and the layers would range in thickness from 0.004″ to 0.009″. Other weights and thicknesses can be used including weights and thicknesses outside the ranges provided.

Similarly, the web can have varying levels of hardness ranging from relatively hard to relatively soft depending on the hardness or softness of the layer or layers of the web. For example, padding layers can be provided in the form of an inner or outer layer or a filling layer and the padding filling layer can include a cushioning material. Several cushioning materials can be provided including bubble materials, shredded or macerated paper or newsprint materials, textile based materials and the like. The web can be uniform in thickness or can vary in thickness. For example, the web can include built up areas for known or anticipated areas of concentrated stress, for example, due to bulging shipping items creating stretching stresses. At these locations a reinforcing member in the form of an internal or external patch can be provided. The preferred embodiment is free of externally positioned patches. Additionally, the web can include breathable materials and/or materials that are not air-permeable. In some embodiments, the web can be treated with water resistant and/or water proof materials. In a preferred embodiment, the web is not coated so as to provide for recycleability. Alternatively, a biodegradable coating or organic waterproofing can be provided. A water based coating that remains recyclable can also be provided such as, for example, Michem.

In the preferred embodiment shown in FIG. 5, the web is in the form of a multi-layer sheet 138. The sheet 138 shown includes an outer layer 140, an inner layer 142, and a filling layer 144. In the present embodiment, the outer and inner layers 140, 142 include relatively flexible layers in the form of paper and the filling layer 144 includes a cushioning material in the form of a macerated newsprint material. As shown, the filling layer 144 can be held back from the edges of each blank to facilitate gluing or otherwise securing the layers to one another.

Referring now to FIGS. 4-7, the surrounding structure of the envelope 100 can be formed from a web in the form of a sheet 138. The sheet 138 can include one or more blanks 180. A blank 180, as shown in FIG. 5 can include one or more portions of the sheet 138 where the portions are formable into an envelope 100. In the case of the envelope 100, the sheet 138 can be cut into multiple blanks 180 and each blank 180 can be folded and secured to form the envelope 100. Closure elements in the form of flaps can be provided on the blank 180 and can be adapted to provide a lid for opening and/or closing the envelope 100. Reinforcing members can be secured to the inner or outer faces of the sides of the envelope 100 to prevent propagation of the slits provided between the flaps of the envelope 100.

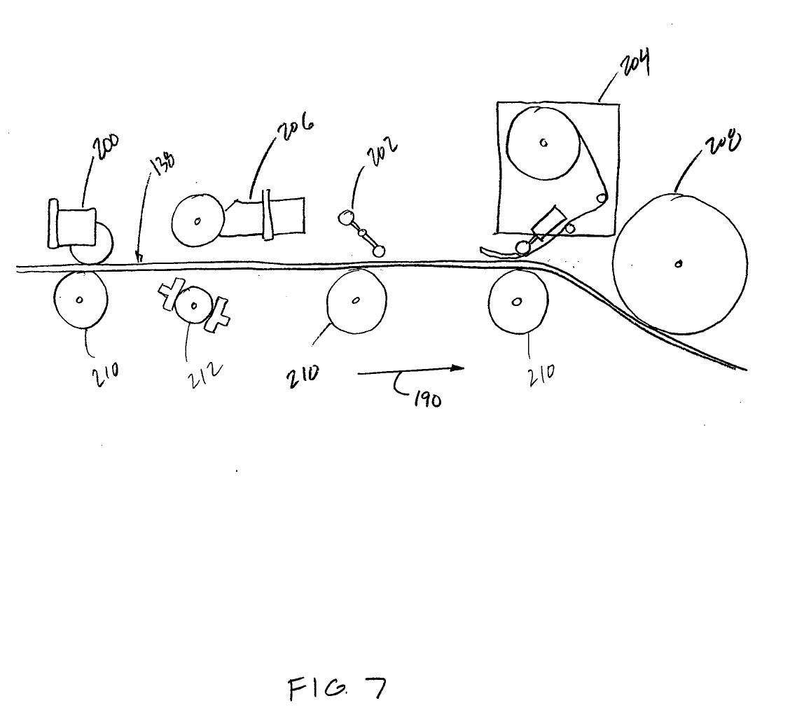

An apparatus for making an envelope 100 is shown in FIG. 7. The apparatus may include a series of rollers 210 for supporting a web or sheet 138. The apparatus may also include a slitter 200, for introducing slits in the sheet 138 and a notcher 212 for introducing a slot 131 in the front flap portion 122 of the front wall 102 to create the cut-out tab 133 for the opening member 134. The slitter 200 and the notcher 212 can be opposed by a roller 206/210 or a hardened back up roller 206/210 to provide a surface against which the slitter 200 and notcher 212 can cut. The apparatus can further include a glue head 202 for applying glue to the surface of the sheet 138. An applicator 204 can be provided for applying reinforcing members 136 to the sheet 138 and a folding wheel can be provided for folding the rows of blanks 180. In the preferred embodiment, the applicator 204 is downstream from the slitter 200 such that the slit length can be adjusted by proper placement of the reinforcing member 136. That is, in cases where the slit 120 is overly long, the reinforcing member 136 can be placed to overlap the base of the slit 120 thereby adjusting the length of the slit 120. Other orientations and orders of the several elements of the apparatus can be provided.

In a preferred embodiment of a method of manufacture of an envelope 100, as shown in FIG. 4, a sheet-type web 138 can be assembled by sandwiching filling material between an outer and inner layer 140, 142. In alternative embodiments, the sheet 138 can comprise multiple filling material layers and the outer and inner layers 140, 142 can include outermost and innermost layers. A glue such as, for example, a polyvinyl alcohol cold or hot melt glue, can be included to secure the outer layer 140 to the inner layer 142. The glue can be applied in a pattern and can bond the outer and inner layers 140, 142 together. The sheet 138 can translate through a processing system in a feed direction 190 as shown in FIG. 4 and FIG. 7. As shown in FIG. 4, the sheet 138 can include multiple areas defining the blanks 180. Preferably, there are two rows of blanks 180 separated by a centerline 182, the centerline defining the location of where the rows of blanks 180 can be separated by a slicer. The blanks 180 include leading edges and trailing edges extending transverse to the feed direction 190, the blanks 180 in each row being separated by cut lines 184 defining the location of where the blanks 180 can be chopped free from the row of blanks 180. The blanks 180 can also include fold lines 186 defining the lateral edges 110 of the front and back walls 102, 104 and, thus, the lateral sides 116 of the envelope 100. The lines 186 can define the location about which the blank 180 can be folded to form the lateral sides 116.

As shown in FIG. 4 and FIG. 7, the sheet 138 can be fed through a processing system. The sheet is shown at a stage just prior to folding by folding wheel 208. The sheet 138 can encounter a slitter 200 creating a slit or slits 120 extending from and generally perpendicular to the leading edge of each blank and positioned along the fold lines for formation of a front wall flap 122 and a back wall flap 124. A glue head 202 as shown in FIG. 7 can be included for applying glue to the surface of the sheet. A reinforcing member 136 can be applied to the surface of the inner and/or outer layer 140, 142. Preferably, the reinforcing member can be a rectangular member and can be applied from a roll of tape positioned in an applicator 204. The reinforcing member 136 can be positioned adjacent the base of the slit 120. The placement of the reinforcing member 136 and the creation of the slits 120 can occur in any order. Preferably, however, the reinforcing member 136 can be applied subsequent the creation of the slit 120 to protect against and/or remedy an overly long slit 120. Where the reinforcing member 136 is applied prior to the slitting process the reinforcing member 136 may not be able to accommodate an overly long slit 120 and the slit 120 may also weaken the reinforcing member 136 by initiating a tear therein. The sheet 138 can also encounter a slicer for separating the rows of blanks 180 into a first row of blanks 180 and a second row of blanks 180, where each row of blanks 180 includes lateral free edges extending generally longitudinally relative to the feed direction 190. Generally, the several parts of the system can be place in any order as described with respect to the slitter 200 and the applicator 204 and are not limited to the order shown in FIG. 7.

The free edges of each row of blanks 180 can be folded about the fold lines 186 via a folding wheel 208, the fold lines 186 defining the lateral sides 116 of the envelopes 100. The free edges can be brought together creating a longitudinally extending seam 146. The free edges can be secured to one another along the seam 146 via an adhering, a stitching, or another connecting process. In a preferred embodiment, this is a polyvinyl alcohol cold glue. Each row of folded blanks 180 can continue to pass through the processing apparatus and a leading folded blank 180 can be chopped free of the subsequent folded blanks 180. As shown in FIG. 6, the trailing end of the chopped off blank 180 can further be glued over an adherence area with an adherence width 117 and the now closed end 112 can be folded over and connected, such as by adhering, to the back wall 104 to create an envelope 100. The process can continue to produce a series of envelopes 100 and the series of envelopes 100 can be stacked and held under compression allowing the closed end 112 glue to set up and take hold.

As also shown in FIG. 6, a folder can then be used to turn down the back wall flap 124 and the flap 124 can be glued to the back wall 104 of the envelope 100 at the opening end 114 of the envelope 100. Referring back to FIG. 1, additionally, a securing member 132 can be positioned on the opening end 114 of the envelope 100 and an opener member 134 can also be provided. In the case of a securing member 132 in the form of an internal adhesive strip, this strip can be adhered to the inside surface of the front wall flap 122. For an opener member 134 in the form of cut-out tab 133 and a pull strip 135, the cut-out tab 133 can be created by the previously mentioned notcher 212. The pull strip 135 can then be adhered to the inside surface of the cut-out tab 133 and further adhered across the inside surface of the front wall flap 122.

In use, a user can insert shipping items through the opening of the envelope 100. As shown in FIG. 3, the back wall 104 of the envelope 100 can be grasped by the user and pulled away from the front wall 102 to facilitate smooth insertion of the shipping item. The reinforcing member 136 can function to resist propagation of the slit 120 extending down the lateral sides 116 of the envelope 100 by securing the back wall 104 to the front wall 102 at the transition point 118. Tension forces from the user passing along the opening edge of the back wall 104 can be transferred across the lateral side 116 of the envelope 100 through the reinforcing member 136 rather than passing directly through the transition point 118. The reinforcing member 136 can then distribute those tensile forces more broadly to the front wall 102 of the envelope 100 thereby preventing propagation of the slit 120 due to tearing of the connection between the front and back walls 102, 104 at the transition point 118. Additionally, where relatively large or bulky shipping items are inserted into the envelope 100, their relatively large size can contribute to tensile forces being transferred across the lateral sides 116 of the envelope 100. In these cases, the reinforcing member 136 can resist propagation of the slit 120 from these tensile forces too.

Once the shipping item is inserted into the containment space, the securing member 132 can be used to secure the front wall flap 124 to the back wall 104 across the opening 126. That is, in the case of an adhesive strip, the strip covering can be removed thereby exposing the adhesive strip and the front wall flap 124 can be folded about the front wall fold line 130 connecting the transition points 118 and pressed against the back wall 104 of the envelope 100 thereby securing it thereto.

Upon receipt of a package by a recipient, the recipient can open the envelope 100 using the opener member 134. The recipient can grasp the cut-out tab located on the front wall flap 122. The tab can then be pulled slightly outward and across the opening end 114 of the envelope 100. Pulling the tab connected to the pull strip can cause the pull strip to tear through the front wall flap 122 creating a torn opening extending across the opening end 114 of the envelope 100. As such, the recipient can then remove the shipped item from the envelope 100.

One having ordinary skill in the art should appreciate that there are numerous shapes and sizes of envelopes for which there can be a need or desire to ship items according to an exemplary embodiment of the present invention. Additionally, one having ordinary skill in the art will appreciate that although the preferred embodiments illustrated herein reflect a generally flat and rectangular envelope, the envelope can have a variety of shapes and sizes.

As used herein, the terms “front,” “back,” and/or other terms indicative of direction are used herein for convenience and to depict relational positions and/or directions between the parts of the embodiments. It will be appreciated that certain embodiments, or portions thereof, can also be oriented in other positions.

In addition, the term “about” should generally be understood to refer to both the corresponding number and a range of numbers. In addition, all numerical ranges herein should be understood to include each whole integer within the range. While an illustrative embodiment of the invention has been disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1. An envelope, comprising:
a first wall with a first edge;
a second wall with a second edge connected to the first edge along a connected portion configured for providing a side of the envelope, the first and second edges respectively including first and second separate portions that are separate from each other, the separate portions extending from the connected portions at a transition location; and
a reinforcing member associated with the connected portion generally adjacent the transition location for reinforcing the connected portion adjacent the transition location.

2. The envelope of claim 1, wherein the reinforcing member is secured to and extends across the first and second edges.

3. The envelope of claim 1, wherein the reinforcing member is adhered to the connected portion.

4. The envelope of claim 3, wherein the reinforcing member includes a strip of sheet material.

5. The envelope of claim 1, wherein the reinforcing member is configured and associated with the connected portion for stopping tearing therethrough from the transition location.

6. The envelope of claim 5, wherein the separate portions are separated by a slit.

7. The envelope of claim 6, wherein the first and second walls define the slit with a sharp tip at the transition location.

8. The envelope of claim 1, wherein the reinforcing member is disposed adjacent to, but not over the separate portions.

9. The envelope of claim 1, wherein the first and second walls include paper sheet material.

10. The envelope of claim 9, wherein the first and second walls are multi-layered, having a plurality of sheet layers, including the paper sheet material.

11. The envelope of claim 10, wherein the plurality of layers includes inner and outer layers of paper sheet material.

12. The envelope of claim 11, wherein the first and second walls include a filling layer disposed between the inner and outer layers.

13. The envelope of claim 12, wherein the filling layer includes a plurality of pellets forming a cushion.

14. The envelope of claim 13, wherein the cushion is macerated paper.

15. The envelope of claim 1, wherein
the first wall includes a third edge; and
the second wall includes a fourth edge connected to the third edge along another connected portion configured for providing another side of the envelope, the third and fourth edges respectively including third and fourth separate portions that are separate from each other, the third and fourth separate portions extending from the another connected portions at another transition location,
wherein, the envelope further comprising another reinforcing member associated with the another connected portion adjacent the another transition location for reinforcing the another connected portions adjacent the another transition location.

16. The envelope of claim 15, wherein the first and second wall and the connected portion and the another connected portion define a containment space therebetween.

17. The envelope of claim 16, wherein the portion of the first wall and the second wall disposed between the separated portions each comprise a flap, the flap of the first wall being foldable over the second wall and secured thereto for closing the envelope.

18. The envelope of claim 17, further comprising an adhesive disposed for adhering the flap of the first wall to the second wall upon contact therebetween.

19. The envelope of claim 1, wherein a first portion of the second wall is positioned adjacent a first side of the first wall separated by a first fold line and a second portion of the second wall is positioned adjacent a second side of the first wall separated by a second fold line, the first and second portions of the second wall being foldable along the fold lines to form a containment space.

20. An apparatus for making an envelope from a sheet, the apparatus comprising:
a plurality of rollers arranged to support the sheet and allow the sheet to pass there across;
a slitter positioned opposed to the plurality of rollers and on an opposite side of the sheet from the plurality of rollers; and
an applicator for applying reinforcing members to the sheet and being positioned downstream from the slitter and on the opposite side.
